(19) United States
(12) Patent Application Publication
(10) Pub. No.: US 2016/0253914 A1
(43) Pub. Date: Sep. 1, 2016

(54) GENERATING AND EVALUATING LEARNING ACTIVITIES FOR AN EDUCATIONAL ENVIRONMENT

(71) Applicant: MIMIO, LLC, CAMBRIDGE, MA (US)

(72) Inventors: Christopher Leonardo, Waltham, MA (US); Karen Mahon, Tyngsboro, MA (US); Manuel Perez, Somerville, MA (US); Joseph Rocco, Walpole, MA (US); Kosmas Karadimitriou, Shrewsbury, MA (US); Alyssa Porter, Norwell, MA (US); Christopher M. Cacioppo, Somerville, MA (US)

(21) Appl. No.: 15/149,028

(22) Filed: May 6, 2016

Related U.S. Application Data
(63) Continuation of application No. 13/595,534, filed on Aug. 27, 2012.
(60) Provisional application No. 61/577,397, filed on Dec. 19, 2011.

(51) Int. Cl. G09B 7/00; G09B 7/07; G09B 7/02

(52) U.S. Cl. CPC G09B 7/00; G09B 7/02; G09B 7/07

(57) ABSTRACT

An educational activity system allows a teacher to specify activity parameters, such as subject, grade level, and template format that define an activity for one or more students to complete on a computer. The system then uses the selected activity parameters to determine appropriate subject matter from a content asset database and generates an activity incorporating the determined appropriate subject matter. After a student completed the activity via a computer, the system evaluates the completed activity for correctness and stores the results of each student in a student performance database.

### FIELD OF TECHNOLOGY

This disclosure relates to automatic generation of learning activities for use in an educational environment, and more specifically, to a system and a method configured to enable a teacher, using only minimal inputs, to automatically generate a learning activity for one or more students.

### BACKGROUND

Computer-aided assessment tests are widely used in a variety of educational or aptitude settings, such as primary and secondary schools, universities, standardized or aptitude tests (e.g., GRE, MCAT, GMAT, state achievement exams, etc.), entrance examinations, and online training courses. For educational settings, computer-aided tests may be employed in both traditional, in-classroom environments and/or remote, networked out-of-classroom settings. For example, a full-time worker requiring flexibility may enroll in an online program with a webbased educational institution and may exclusively conduct all his or her exams via computer-based tests. As another example, traditional educational institutions, and in particular, elementary education systems, are increasingly employing in-class computer-based tests and other individual and group learning activities with their students. Generally, computer-based activities and tests lower the costs of teaching by automating the evaluation of each student's exam and by liberating a teacher's time grading exams. However, the teacher is still required to manually create computer-based tests for his or her students despite saving time in grading the tests.

One conventional technique for creating a computer-based activity or test involves a teacher manually formulating a computer-based test by writing his or her own questions and entering the questions into the computer. Although this task is an easy method of creating a computer-based activity or test, it quickly becomes time consuming and difficult to create multiple computer-based activities or tests for different subjects or grade levels or to edit existing activities or tests. Another conventional technique for creating a computer-based activity or test includes utilizing a repository of previously entered activity test material, content, or test questions. In this case, the teacher or a third party entity must diligently draft each question or test material item that is to be stored in the repository; then the teacher may choose questions or material residing in the repository to manually create a computer-based activity or test. While creating an activity or test more quickly than writing each question from scratch, the teacher still is required to choose each question or instructional item manually. Furthermore, this technique may not perform well in all settings, especially when the content or test material in the repository must be frequently changed or updated. This technique is particularly tedious and time consuming with the inclusion of an extremely large repository, such as the online aggregate website, Multimedia Educational Resource for Learning and Online Teaching (MERLOT). In that case, the teacher must painstakingly sift through vast amounts of test material, choose the test material closest to the teacher's lesson plan, and then typically modify the material to suit the students' needs. Likewise, this technique is also inadequate with a small repository because of the insufficient depth in the number of questions from which to select.

### SUMMARY

An educational activity system, according to one example embodiment, allows a teacher user to specify activity parameters that define an activity for one or more students to complete on a computer or a mobile device, uses the activity parameters to determine appropriate subject matter from a content asset database, generates an activity incorporating the determined appropriate subject matter, evaluates generated activities for correctness after a student has completed the activity, and stores the results of each student in a student performance database. To create an activity, the activity editor retrieves all subject, grade level, and activity template data from a knowledge database and displays the subject, grade level, and activity template data to the teacher user. The teacher user selects the appropriate subject, grade level, and activity template data that the system will use in creating an activity. Using the teacher user selected data, the activity editor retrieves applicable topic data in the knowledge database for use in creating the activity and displays the topic information to the teacher user. The teacher user specifies the appropriate topic data for use in the activity. The activity editor retrieves all appropriate categories from the knowledge database that correspond to the teacher user selected topic and displays the category information to the teacher user. The teacher user selects the desired categories, and the activity editor retrieves all items associated with the teacher user specified categories from an asset database and randomly displays a portion of the items to the teacher user at a preview layout activity creation stage. At the preview layout stage, the teacher user may customize each specific value by determining whether to include or to omit particular items in the activity for the one or more students. The activity editor stores the created activity in an activity database. When an authorized student user requests to perform the activity, an inference engine retrieves and displays the activity to the student user. According to some embodiments, after recording the student user's selections or responses to the activity, the inference engine may be further employed to evaluate the activity for correctness and store the results in a student performance database for later retrieval by the teacher user, or for automatic generation of subsequent activities, with modification of level of difficulty according to student performance on the completed activity. To perform automatic generation of subsequent activities, the inference engine may maintain initial values for each of the teacher-specified subject, grade level, and activity template data, regenerate a new filtered set of test items based on these maintained initial values, and recreate a new electronic activity using the regenerated filtered set of test items.

### BRIEF DESCRIPTION OF THE DRAWINGS

FIG. 1 is a high-level block diagram of a computing environment that implements an electronic activity editing system that automatically and intelligently generates electronic activity;

FIG. 2 is a high-level block diagram illustrating modules within an activity editor;

FIG. 3 is a high-level block diagram illustrating modules within an inference engine;

FIG. 4 illustrates an example routine or a process flow diagram for creating and storing an educational activity for one or more students and for executing an activity for a student user and storing the results of the activity for the student in a student performance database;

FIG. 5 illustrates an example visual display that may be produced by an inference engine and an activity editor that presents available subjects, grade levels, and templates to enable a teacher user to create an activity;

FIG. 6 illustrates an example visual display that may be produced by an inference engine and an activity editor that presents available topics associated with a previously specified subject and a previously specified grade level to enable the teacher user to further tailor a desired activity;

FIG. 7 illustrates an example visual display that may be produced by an inference engine and an activity editor that presents available categories associated with a previously specified topic to enable the teacher user to further customize a desired activity;

FIG. 8 illustrates an example visual display that may be produced by an inference engine and an activity editor that presents available items associated with a previously specified category or categories to enable the teacher user to individually choose, if desired, for the activity in a preview layout stage;

FIG. 9 illustrates an example visual display that may be produced by an inference engine that presents a finalized activity to enable a student user to match each item to its appropriate category.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the earliest effective filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

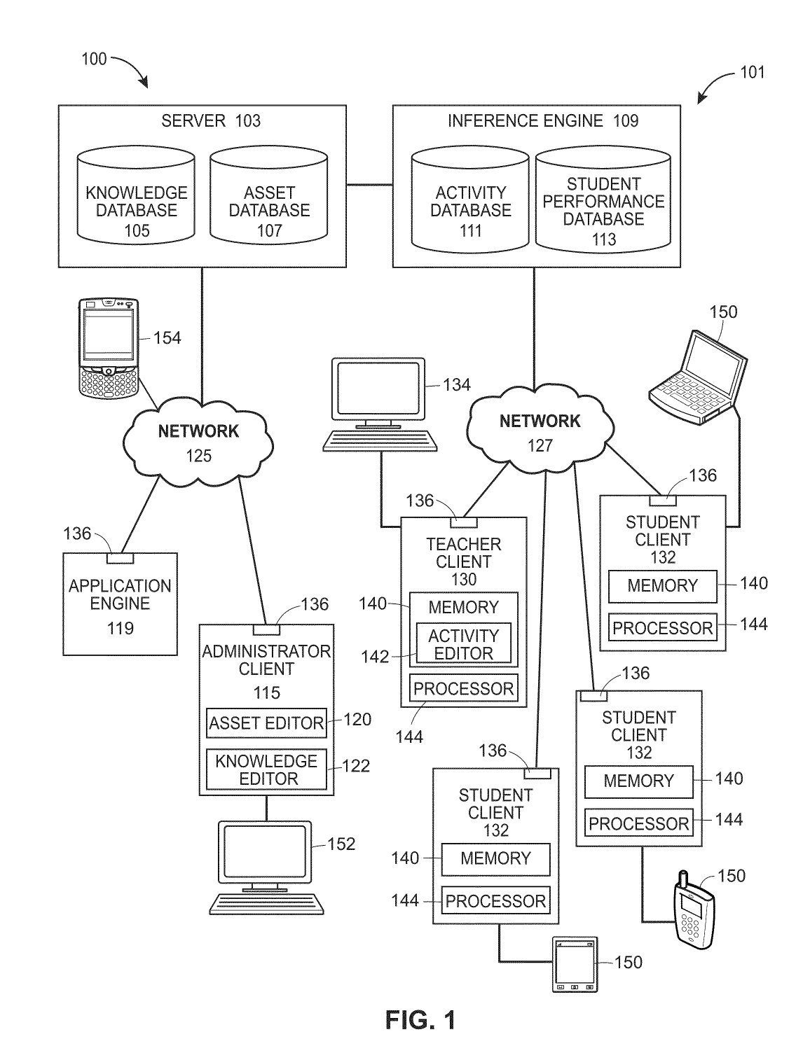

FIG. 1 is a high-level block diagram that illustrates a computing environment for a test material editing system 100 and an inference engine system 101 that may be used to automatically and intelligently create an educational activity through minimal inputs of a teacher user and to store the activity for one or more students to complete at a later time. The inference engine system 101 may include an activity database 111, student performance database 113, and an inference engine 109 that is connected to one or more teacher clients 130 and student clients 132 through a communication network 127. The activity database 111 and student performance database 113 may be connected to or may be disposed within the inference engine 109 which may be, for example, implemented in a server having a computer processor (not shown) and a computer readable medium or storage unit (not shown) of any desired type or configuration. Each teacher client 130 may include a computer processor 144, a computer readable memory 140, and a network interface 136. The computer readable memory 140 may store an activity editor 142 that communicates with the activity database 111 via an associated network interface 136. Alternatively, the activity editor 142 may be stored in the inference engine 109 and be accessible via a web interface. Any particular teacher client 130 may also be connected to or may be disposed within an asset editor 120 or knowledge editor 122 (discussed below). Each student client 132 may include a computer processor 144, computer readable memory 140, and a network interface 136 to communicate with the inference engine 109. Any particular teacher client 130 or particular student client 132 may be connected to or may be disposed within a user interface device 134 that may be for example, a hand-held device, such as a smart phone or tablet computer, a mobile device, such as a mobile phone, a car navigation system or computer system, a computer, such as a laptop or a desktop computer, an electronic whiteboard, or any other device that allows a user to interface using the network 127. While only three student clients 132 and one teacher client 130 are illustrated in FIG. 1 to simplify and clarify the description, it is understood that any number of student clients 132 or teacher clients 130 are supported and can be in communication with the inference engine 109.

The test material database editing system 100 includes a server 103 that is connected to a administrator client 115 through a communication network 125. The asset database 107 is connected to or is disposed within the server 103 and stores test content data, or asset data, of any type, including for example, pictures, images, diagrams, illustrations, silhouetted images, words, phrases, sentences, paragraphs, sounds, music, animation, videos, dynamic objects (e.g., a multimedia platform), and lessons. Generally speaking, the data stored in the asset database 107 may be any data that is presented to a student while performing an activity and/or available for selection and incorporation into an activity by a teacher user. The knowledge database 105 is in communication with or is disposed within the server 103 and stores relational data of any type, including for example concepts, attributes, relationships, and taxonomical information. In general, the relational data stored in the knowledge database 105 may be of any data that adds context or relational knowledge to the asset data in the asset database 107 (discussed below) and can be structured using any manner or technique.

The administrator client 115 stores an asset editor 120 and knowledge editor 122 and may include a user interface 152. The asset editor 120 communicates with the asset database 103 via a network interface 136 and operates to enable a user to create, to add, to delete, or to edit asset in the asset database 107. Similarly, the knowledge editor 122 communicates with the knowledge database 105 via the network interface 136 and operates to enable a teacher user to create, to add, to delete, or to edit relational data in the knowledge database 105. As illustrated in FIG. 1, the server 103 may also be connected to and may communicate with one or more application engines 119 through the communication network 125 via a network interface 136. The application engine 119, which may be stored in a separate server, for example, is connected to an application client 154 through the communication network 125, for example, and may operate to create and store application data and to communicate this application data to the asset database 107 and knowledge database 105. Application data may be any data generated or stored by an application of any type that pertains to, that is associated with, or that is related to the asset data stored in the asset database 107 or related to relational data in the knowledge database 105. The application engine 119 can be stored in external storage attached to the server 103, stored within the server 103 or can be stored within the application client 154 or in the inference engine 109. Additionally, there may be multiple application engines 119 that connect to the asset database 107 and the knowledge database 105.

The communication networks 125 and 127 may include, but are not limited to, any combination of a LAN, a MAN, a WAN, a mobile, a wired or wireless network, a private network, or a virtual private network. Moreover, while the communication networks 125 and 127 are illustrated separately in FIG. 1 to simplify and clarify the description, it is understood that only one network or more than two networks may be used to support communications with respect to the administrator clients 115, the application client 154, the teacher clients 130, and the student clients 132, or some or all may be in direct communication or stored and executed on the same system component or components. Moreover, while only one application client 154 is illustrated in FIG. 1, it is understood that any number of application clients 154 are supported and can be in communication with the application engine 119.

As indicated above, the asset database 107, which may be stored in or may be separate from the server 103, may contain any type of test content data and is stored as data objects or asset data. Generally, asset data may be stored in any form of media, such as visual, or auditory media, and in any format (as discussed above). Any information associated with a particular asset data, such as metadata, keywords, tags, or hierarchical structure information, may also be stored together with the particular asset data. For example, a particular asset data in the asset database 107 may include an image depicting a bear eating a fish from a river in a forest. In this example, the keywords or tags might include “bear”, “fish”, “forest” and/or “bear eating fish.” These keywords or tags are stored together with the image in the asset database 107 as associated information to the image. Tags or keywords link asset data (e.g., an image) to facts or concepts contained within the asset data (e.g., “bear”, “fish”, “forest”). By tagging asset data with facts or concepts, the asset data is easily linked or integrated with the relational data in the knowledge database 105.

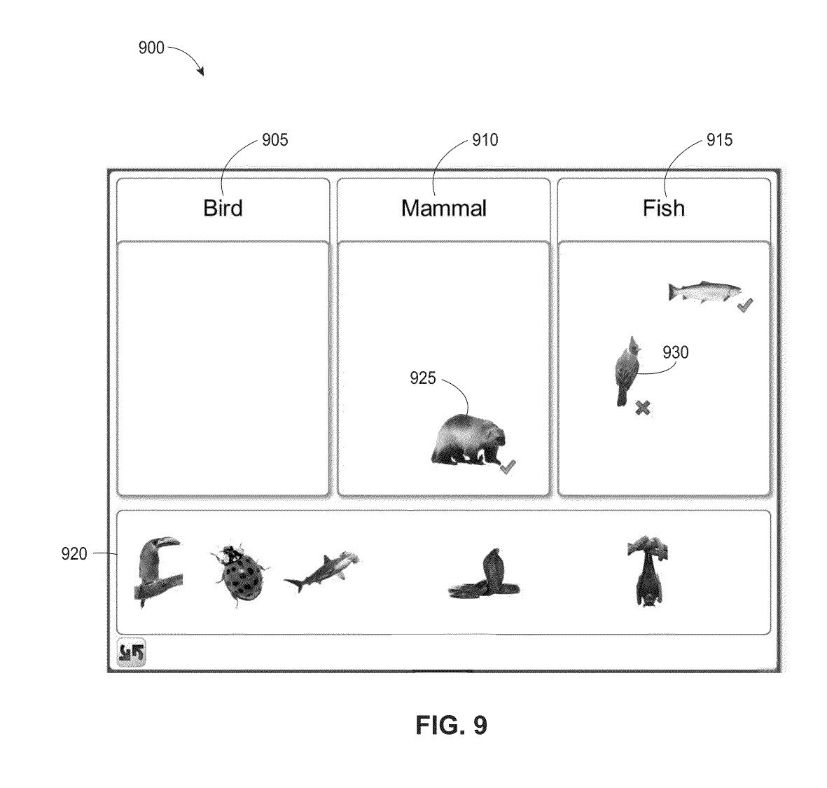

In addition to storing asset data, the asset database 107 may also store one or more template types that define the tasks or goals of an activity. Of course, template types may be stored in the knowledge database 105, the activity database 111, the activity editor 142, or any other suitable location. For example, a template type may be chart template that includes three columns and a selection area of test items that area selected by a teacher user or determined by the inference engine 109 (discussed in more detail below and in FIG. 9). Each column represents a different category in a particular topic that is specified by a teacher user or that is determined by the system. For example, a teacher user may select the topic of animal classifications and assign the three columns to represent different selected categories under animal classifications. In this example, the three columns may represent birds, mammals, and fish, respectively. Each task in the activity requires the student user to drag individual test items, such as a bear, a salmon, or a toucan, from the selection area to the appropriate column or category. Other template types may include charts containing any number of columns, tables containing any number of rows or columns, matching exercises, Venn diagrams, labeling exercises, sequencing or timeline exercises, life cycle exercises, cause and effect exercises, mathematical or scientific equation and formula exercises, text annotation exercises, correction of inaccurate statement exercise, or the like.

As indicated above, the knowledge database 105, which may be stored in or may be separate from the server 103, may contain any type of relational data that links facts and concepts in a network of complex relationships. As discussed above, this relational data may include, for example, concepts, facts, attributes, relationships, or taxonomical information. For example, all relational data (i.e. any data that relates one item of data to another item of data) may be generally classified as a characteristic of an item of factual data. Relational data may describe, link, associate, classify, attribute, give sequence to, or negate the item of factual data to different relational data or another item of factual data. While this relational data may be stored in the knowledge database 105 in any number of ways, manners, or schemas, the Entity-Attribute-Value (EAV) modeling technique is well suited in organizing relational concepts. In other words, the EAV model expresses concepts in a three-part relationship element that defines 1. an entity's 2. relationship to 3. another entity or value (i.e. a common format includes [1. entity, 2. relationship/attribute, 3. another entity/value]). For example, a relational data element might include the conceptual relationship of “a bear is a mammal”, or as it may be alternatively stored as an entry in the knowledge database 105, [bear, isa, mammal]. Another example entry may include the entry, “mammals have hair” or [mammal, skin cover, hair]. The following chart lists (but is not limited to) a series of examples of other EAV model or relational data elements:

| ENTITY | ATTRIBUTE | VALUE |
|---|---|---|
| animal | isa | living organism |
| plant | isa | living organism |
| mammal | isa | animal |
| bird | isa | living organism |
| bear | isa | mammal |
| fish | isa | living organism |
| bear | isa | legged animal |
| legged animal | isa | animal |
| bear | isa | omnivore |
| snake | isa | reptile |
| reptile | isa | living organism |
| desert | isa | habitat |
| ocean | isa | habitat |
| forest | isa | habitat |
| lake | isa | habitat |
| river | isa | habitat |
| dolphin | isa | mammal |
| bear | food source | fish |
| bear | foot type | paws |
| bear | number of legs | 4 |
| bear | skin cover | fur |
| fish | habitat | body of water |
| bear | habitat | forest |
| dolphin | habitat | ocean |
| ocean | isa | body of water |
| lake | isa | body of water |
| river | isa | body of water |
| dolphin | locomotion | swim |
| bear | ability | swim |
| fish | locomotion | swim |
| legged animal | locomotion | walk |
| dolphin | body part | fins |
| dolphin | body part | tail |
| omnivore | food source | everything |
| omnivore | food source | plant |
| carnivore | food source | meat |
| herbivore | food source | plant |
| reptile | skin cover | scales |
| mammal | ability | walk |
| mammal | ability | jump |
| elephant | ability | walk |
| elephant | habitat | jungle |
| elephant | geographic region | africa |
| mammal | number of legs | 4 |
| dolphin | number of legs | 0 |
| mammal | body part | legs |
| mammal | reproduction | live young |
| platypus | isa | mammal |
| platypus | reproduction | eggs |
| platypus | !reproduction* | live young |
| athens | isa | city |
| greece | isa | country |
| greece | capital | athens |
| greece | population | 10 million |
| thunder | prerequisite | clouds |
| lighting | prerequisite | clouds |
| rain | prerequisite | clouds |
| rain | result | puddles |
| frog egg | isa | egg |
| frog | isa | amphibian |
| amphibian | isa | animal |
| orca | aka | killer whale |
| frog | reproduction | eggs |
| tadpole | precedes | frog |
| frog | habitat | river |
| frog | habitat | lake |
| baseball: bat | isa | object |
| animal: bat | isa | mammal |
| animal: bat | ability | fly |
| bear | food source | salmon |

*The “!” before an attribute denotes its logical negative. For example, “!reprosuction” equates to a platypus not giving birth to live young.

In utilizing these EAV model elements, the inference engine 109 is capable of linking identical sub-elements of two relational data elements together so that new relationships dynamically emerge via deduction and can be automatically generated by the inference engine 109 as further described herein. In utilizing the EAV model, the inference engine 109 is capable of using the complex relationships that are dynamically created with each EAV relational data element entry into the knowledge database 105. Opposed to a fixed, simple hierarchical-designed data structure, the EAV model allows for the linking of different entities and values via attributes. In returning to the example above, the inference engine 109 may use the relational data entry [bear, isa, mammal] and relational data entry [mammal, skin cover, hair] to deduce “a bear has hair” or [bear, skin cover, hair] via linking identical sub-elements. This deduction would not be possible in a simple, hierarchal-designed data structure due to the rigidity of a hierarchy data structure. To implement this EAV model, for example, the inference engine 109 first stores all relational data entries within the knowledge database 105 into memory 140 at runtime and deduces new relationships among the stored relational data entries. In this example, the inference engine 109 infers a new relationship, “a bear has hair,” from the two relational data entries, “a bear is a mammal” and “mammals have hair,” and uses the new relationship when generating new activities. In other words, a sub-element may inherit the attributes and values of another sub-element in the process of deduction. In the example above, the sub-element “bear” inherits the all the same attributes (“skin cover”) and values (“hair”) as another sub-element (“mammal”) through the inferring of the inference engine 109. Through this hierarchical linking and inheritance structure of the EAV model, the inference engine 109 may dynamically determine topics and the respective categories. Examples of topics or attributes may include animal classification, skin cover, reproduction, capital cities, habitat, etc. Example categories for a specific topic, for instance skin covers, may include fur, scales, feathers, etc. Of course, topics and categories may be interchangeable and previous listed examples are not intended to limit the relationship or defining characteristics between entities. As seen from the chart above, the relationship between the entity and an another entity (or value) may be defined by an variety of attributes that may characterize a specific property or a specific value to the entity.

More generally, the different types of attributes may include classification attributes, descriptor attributes, relational attributes, sequential attributes, equivalent attributes, negative attribute, etc. A relational data element that includes a classification attribute type may result in an entity inheriting attribute values associated with an attribute value directly associated with the respective entity by way of the classification attribute. For example, a relational data element entry with the properties, [bear, isa, mammal], results in the entity (bear) inheriting (isa) the classification or properties of the value (mammal) by way of being associated together in the relational data element. Another attribute type may include a descriptor attribute type that may define one or more descriptions of an entity by a corresponding attribute value. As a result, entities from multiple relational data elements having common descriptor attribute types and corresponding attribute values are determined to be related. For instance, a relational data element entry with the properties, [bear, food source, salmon], results in the entity (bear) being defined as including the value (salmon) as a food source. Additional examples of descriptor attribute types include habitat type, reproduction type, number of legs type, locomotion type, capital city type, etc. An additional attribute type includes a relational attribute type that may define how an entity relates to an attribute value. As shown in the chart, the relational data element, [rain, prerequisite, clouds], relates the entity (rain) to the value (clouds) via a prerequisite requirement that clouds be must present for rain to exist. The sequential attribute type may define a sequential relationship between an attribute value and an entity of a relational data element. For example, the relational data element, [tadpole, precedes, frog], defines the sequential relationship between an entity (tadpole) and a value (frog) so that a tadpole must always occur before a frog. The equivalent attribute type may indicate that an attribute value and an entity are equivalents of each other. The example relational data element, [orca, aka, killer whale], equivocates the entity (orca) with the value (killer whale) so that the inference engine 109 treats the entity and value exactly same. The negative attribute type may indicate that an attribute value is not associated with an entity despite potentially other inheritances. For example, the relational data element, [platypus, !reproduction, live young], indicates that the entity (platypus) does not inherit a specific value (live young) despite other relational data elements, [platypus, isa, mammal] (a platypus being a mammal) and [mammals, reproduction, live young] (mammals give birth to live young) that would indicate an inheritance of those properties.

In addition, each relational data element may also include a grade level tag that indicates the age or the grade level appropriateness of the test material. In other words, the grade level tag may also be considered a difficulty level tag in denoting the level of difficulty of the relational data element. This grade level tag may be associated with a relational data element or one sub-element of a relational data element, and as such, the term “grade level” may generally mean level of difficulty and is not necessarily tied to an academic grade or other classification. For example, [bear, isa, mammal] may be associated with a grade level of 2, an age level of 8, grade range of K-2, or age range of 6-8, while the sub-element [bear] may be associated only with a grade level of 1, an age level of 6. In this manner, the inference engine 109 may only retrieve age level, grade level, age range, or grade range appropriate relational data from the knowledge database 105 by inspecting the grade level tag associated with the relational data.

During operation, the inference engine system 101 communicates with the test material database editing system 100 through the communicative coupling of the inference engine 109 and the server 103. First of all, this communicative coupling allows the inference engine 109 to retrieve knowledge data from the knowledge database 105 for use in inferring and determining appropriate test material for a specific activity. Moreover, this communicative coupling allows the inference engine 109 to retrieve asset data from the asset database 107 for displaying content within an activity to the user. This communicative coupling may also permit the server 103 to send an update message that makes the inference engine 109 aware of an update made to data stored within the asset database 107 or knowledge database 105 so that the inference engine 109 may alert the teacher client 130 that new test material is available.

In a general example scenario, a teacher user may wish to create an activity that tests a particular subject and specific grade level for one or more students. Moreover, the teacher user may also want to specify a template or a format for the activity that is most suitable for the students who will be performing the activity. To do so, the teacher user interfaces with the activity editor 142 via a user interface 134. The activity editor 142 sends a request to the inference engine 109 to display all or a subset of available subjects, grade levels, and activity templates. It is appreciated that in other embodiments, a teach user may not select a subject, grade level, and activity template always, but instead may only select one or two of those options, such as a grade level and subject (while, for example, an activity template is selected automatically), or only a subject, for example. Similarly, in other embodiments, a teacher user may select multiple different values for one or more of the grade level, subject, and/or templates (or any other selection described herein), which may allow for a more varied activity to be generated and/or allow narrowing the multiple choices by the inference engine 109 logic. In response to the request from the activity editor 142, the inference engine 109 retrieves all or a subset of subject data, grade level data, and template types from the knowledge database 105 and conveys the subject data, grade level data, and template types to the activity editor 142 for display to the teacher user in selecting an appropriate subject and grade level to be associated with the activity. The teacher user specifies one or more of the desired subject, grade level, and template type for the activity via the user interface 134, and the activity editor 142 communicates the selected subject, grade level, and template type to the inference engine 109 and requests at least a subset of the topic data that is associated with the specified subject and grade level. The inference engine 109 stores the template type associated the activity in the activity database 111 for later use in the preview layout stage. In response to a request for topic data associated with the specified subject and grade level, the inference engine 109 retrieves all topic data associated with the selected subject and grade level from the knowledge database 105 and relays at least a subset of the topic data to the activity editor 142 to display to the teacher user.

The teacher user chooses the desired topic (or a combination of topics, in other examples) for the activity via the user interface 134, and the activity editor 142 communicates the specified topic to the inference engine 109. In response to the request from the activity editor 142, the inference engine 109 retrieves all or a subset of category data from the knowledge database 105 that associated the topic specified by the teacher user and relays the retrieved category data to the activity editor 142 to display to the teacher user. The teacher user selects one or more categories via the user interface 134, and the activity editor 142 conveys a request to the inference engine 109 to display all or a subset of items associated with the one or more selected categories. In response to the request of the activity editor 142, the inference engine 109 retrieves all or a subset of item data associated with the specified one or more categories from the asset database 107 and relays the retrieved item data to the activity editor 142 to display to the teacher user in a preview layout stage. In the preview layout stage, the activity editor 142 displays all the received items in a library section and randomly pre-populates a portion of the items in the library in a choice pool area. Items randomly displayed in the choice pool are proposed to be included in the activity for the one or more students. At this preview layout stage, the teacher user may wish to include additional items from the displayed library in the choice pool or may wish to remove items that are pre-populated by the inference engine 109 from the choice pool. The teacher user may include additional items or may remove pre-populated items via the user interface 134. When the teacher user is satisfied with the items residing in the choice pool and wishes to create the activity, the activity editor 142 communicates the selected items in the choice pool to the inference engine 109 and requests (signals) that the inference engine 109 create the activity. In other embodiments, the teacher user may not be given the choice to modify item data. In response to the request from the activity editor 142, the inference engine 109 stores the selected item data from the choice pool received from the activity editor 142 within the activity database 111 in conjunction with the previously selected template type. Together with the selected item data and template type data, the inference engine 109 may also store additional activity data in the activity database 111, such as information associated with the activity which may include the teacher user's information, and activity creation date.

It is appreciated that, according to other embodiments, some or all of the activity creation and selection operation may not be performed by a teacher but may instead be performed by an administrator or third-party service provider. For example, in a third-party service provider model where multiple activities are pregenerated and provided (sold, licensed, hosted, etc.) to a teaching institution already configured and ready to be utilized, instead of a teacher generating the activities (and making some or all of the subject, grade level, template, topic, category, item choices), these may be performed by a third-party administrator. It is therefore appreciated that, in some embodiments, some or all of the actions described as being performed by a teacher user may be performed by another party.

Thereafter, an authorized student user may request the activity from the inference engine 109 via a user interface 150. In response to the request, the inference engine 109 retrieves the stored activity that is associated with the student user from the activity database 111 and relays the activity to the student client 132 to display to the student user. It is appreciated that, according to other embodiments, an activity may be generated for printing a hard copy, allowing a student to complete the activity on paper and without a computer or other student client 132 device. According to one embodiment, as the student user performs each task or question of the activity, the student user's response is transmitted as task result data to the inference engine 109 for evaluation. In response to the request from the student client 132, the inference engine 109 evaluates the task result data for correctness, generates corresponding evaluation data, stores the result data and the evaluation data as student performance data associated with the student user in the student performance database 113, and sends the evaluation data to the student client 132 to display to the student user for immediate feedback. At any time, the teacher user may request the task result data and the evaluation data of the particular student from the inference engine 109 via the user interface 134 of the teacher client 130. In response to the request, the inference engine 109 may retrieve the task result data and the evaluation data associated with the particular student from the student performance database 113 and relay the task result data and the evaluation data to the teacher client 130 to display to the teacher user.

Of course, the activity data stored in the activity database 111 can be created or accessed by multiple activity editors 142 (other activity editors not shown), can be modified, and can be stored back into the activity database 111 at various different times to create and modify activities. As will be understood, the activity database 111 does not need to be physically located within inference engine 109. For example, the activity database 111 can be placed within a teacher client 130, can be stored in external storage attached to the inference engine 109, can be stored within server 103, or can be stored in a network attached storage. Additionally, there may be multiple inference engines 109 that connect to a single activity database 111. Likewise, the activity database 111 may be stored in multiple different or separate physical data storage devices. Furthermore, the inference engine 109 does not need to be directly connected to the server 105. For example, the inference engine 109 can be placed within a teacher client 130 or can be stored within the server 105. Similarly, the student performance data stored in the student performance database 113 may be accessed by multiple activity editors 142, can be modified, and can be stored back into the student performance database 113 at various different times to modify student performance data, if necessary. The student performance database 113 need not be located in the inference engine 109, but for example, can be placed within a teacher client 130, can be stored in external storage attached to the inference engine 109, can be stored within server 103, or can be stored in a network attached storage. Additionally, there may be multiple inference engines 109 that connect to a single student performance database 113. Likewise, the student performance database 113 may be stored in multiple different or separate physical data storage devices.

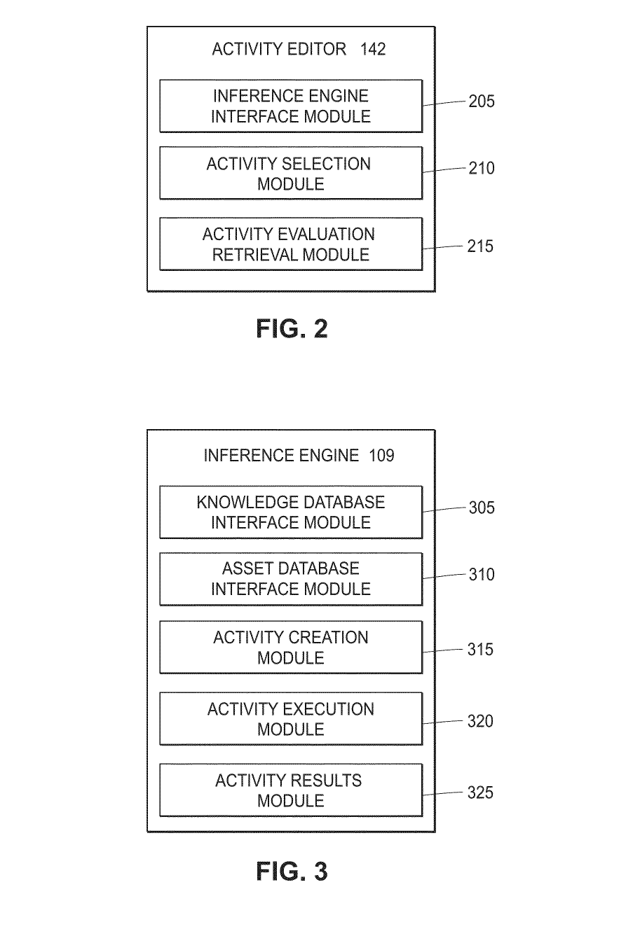

FIG. 2 illustrates an example high-level block diagram depicting various modules within or associated with one of the activity editors 142 that may be implemented to perform user interfacing with the inference engine 109, the activity database 111, and the student performance database 113 and to create an activity as described herein. As illustrated, the activity editor 142 may include an inference engine interface module 205, an activity selection module 210, and an activity evaluation retrieval module 215. Generally speaking, the inference engine interface module 205 operates to retrieve activity data from the activity database 111 and student performance data from the student performance database 113 in addition to retrieving relational data from the knowledge database 105 and asset data from the asset database 107 via the inference engine 109. The inference engine interface module 205 also serves to send activity creation data, such as subject data, grade level data, and template type data, to the activity database 111 for storage as part of a created activity. The activity selection module 210 is a user interface module that enables a user to select specific activity creation data, or criteria, such as subject, grade level, or template type that the system uses to determine appropriate test material and to create an activity with that test material. After an activity is created and one or more students complete the created activity, the activity evaluation retrieval module 215 retrieves results data from the student performance database 113 for the teacher's assessment.

FIG. 3 illustrates an example high level block diagram depicting various modules within or associated with the inference engine 109 that may be implemented to perform activity creation, evaluation, and administration. As illustrated, the inference engine 109 may include a knowledge database interface module 305, an asset database interface module 310, an activity creation module 315, an activity execution module 320, and an activity results module 325. Generally speaking, the knowledge database interface module 305 retrieves relational data from the knowledge database 105 in the process of determining appropriate relational data for a particular activity and relaying that relational data to the activity editor 122. The asset database interface module 310 retrieves content data from the asset database 103 in the process of relaying content data to the activity editor 122. Using the selection activity creation data obtained from the teacher user, the activity creation module 315 relies on retrieved relational data from the knowledge database 105 to infer appropriate test material for a specific activity. The activity creation module 315 creates the activity by incorporating content data, retrieved from the asset database 107. The activity execution module 320 operates to send a requested activity to a student client 132 for completion. The activity results module 325 serves to process a completed activity for correctness and store the results in a student performance database 113.

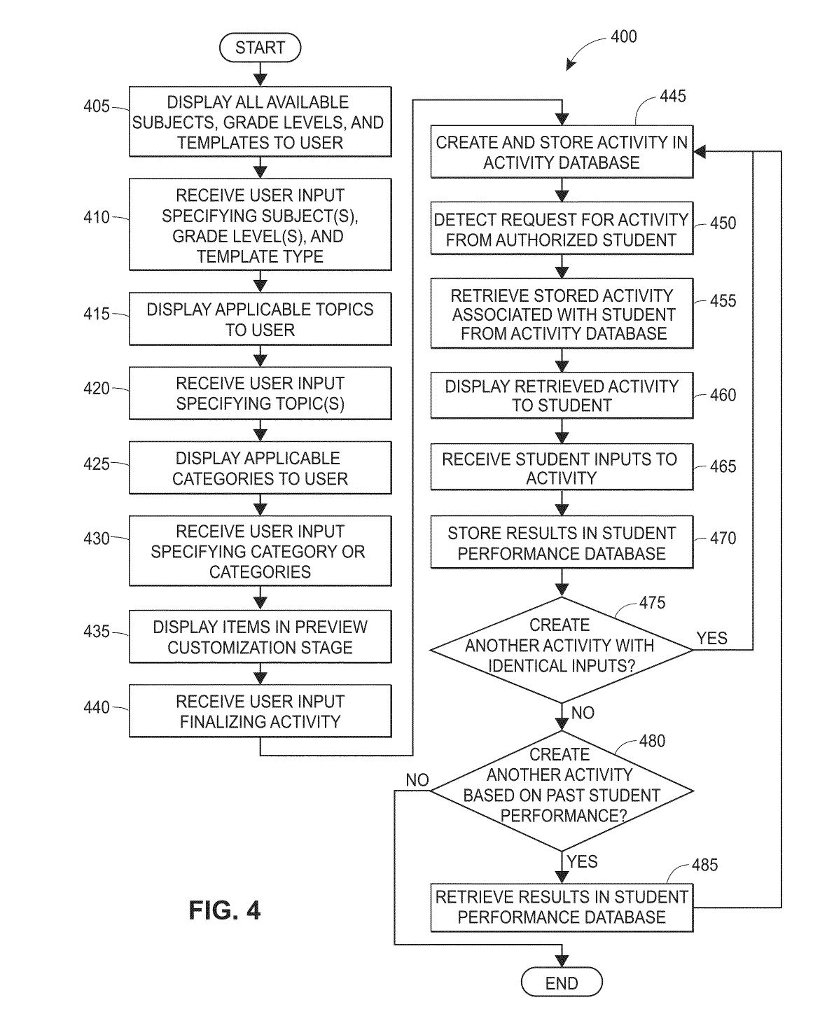

Of course, some embodiments of the activity editor 142 and the inference engine 109 may have different and/or other modules than the ones described herein. Similarly, the functions described herein can be distributed among the modules in accordance with other embodiments in a different manner than that described herein. However, one possible operation of these modules is explained below with reference to FIGS. 4-11.

FIG. 4 illustrates a routine or a process flow diagram 400 associated creating an educational activity and more particularly with accessing all available subject data, grade level data, and template data from the knowledge database 105 and displaying the subject data, grade level data, and template data to the teacher user (implemented by modules 205 and 305), selecting one or more subjects, one or more grade levels, and a template type displayed to the teacher user (implemented by module 210), accessing topic data from the knowledge database 105 and displaying the applicable topic data to the teacher user (implemented by modules 210 and 305), selecting one or more topics displayed to the teacher user (implemented by module 210), accessing category data from the knowledge database 105 and displaying the applicable category data to the teacher user (implemented by modules 210 and 305), selecting one or more categories displayed to the teacher user (implemented by module 210), accessing item data from the knowledge database 105 and displaying the applicable item data to the teacher user in a preview customization stage (implemented by modules 210 and 310), receiving a request to finalize the activity (implemented by module 210), creating an activity with selected template type (implemented by module 310), storing the activity in the activity database 107 (implemented by module 310), detecting a request for an activity from a student (implemented by module 320), executing the activity for the student (implemented by module 320), receiving the student's inputs to the activity (implemented by module 320), evaluating the student's results (implemented by module 320), and storing the results in a student performance database 113 (implemented by module 325). The routine 400 also may create additional activities using the same inputs as the user initial inputs (implemented by module 320) or may create additional activities based on the results of past student performance (implemented by module 320). In this latter case, the routine 400 retrieves results from a student performance database 113 (before implemented by module 325) and uses the retrieved results as inputs to create a new activity.

More particularly, at a step or a block 405, the inference engine interface module 205 within activity editor 142 operates to present all available subjects, grade levels, and templates to the teacher user via the user interface 134. The inference engine interface module 205 will use the knowledge database interface module 305 within the inference engine 109 to access the knowledge database 105 within the server 103 to obtain the relational data needed for display. The displayed subjects, grade levels, and templates may be rendered in text, images, icons, or any other suitable type of data representation. It is appreciated that, according to some embodiments, only a subset of the subjects, grade levels, and templates may be presented. Similarly, in some embodiments, a teacher user may not be presented the option to select each of the subject, grade level, or template options, but instead these may default to predetermined values (e.g., if set in preferences based on teacher user grade taught, teacher user subject matter taught, or template preferences) or some or all selections may be generated randomly (e.g., random template generation). It is further appreciated that, in some embodiments, user preferences may be specified and customizable at different levels of control and association, such as different template preferences for different grade levels, subjects, etc.

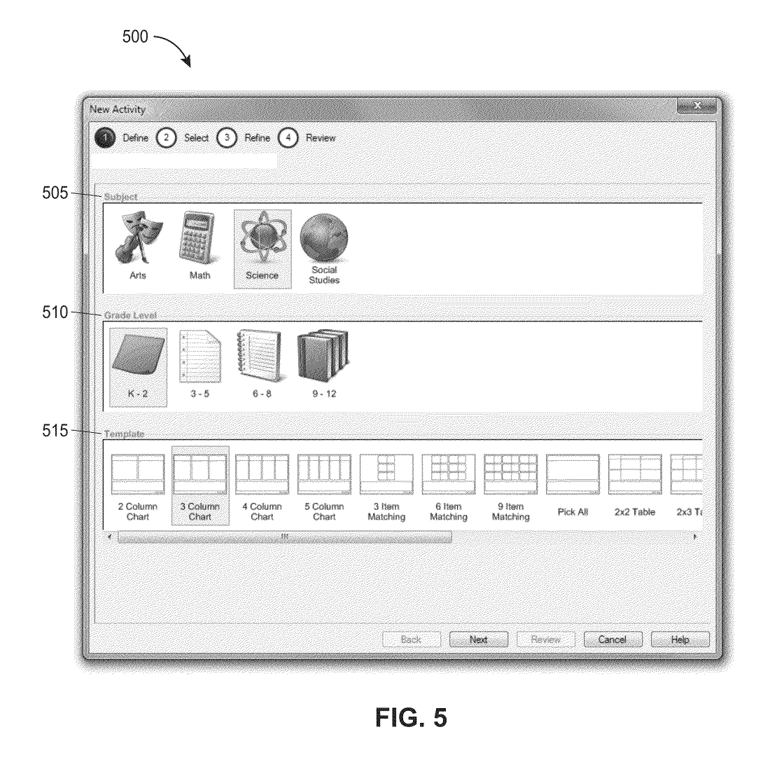

At a block 410, the activity selection module 210 enables a teacher user to highlight or select the desired subject, grade level, and template type via the user interface 134 to thereby define one or more subjects, the one or more grade levels, and the template type to be associated with a particular activity. In one example illustrated in FIG. 5, the block 410 may display in an activity creation window 500, on the user interface 134, all available subjects, grade levels, and templates that were retrieved from the knowledge database 105 by the knowledge database interface module 305. The activity selection module 210 enables the teacher user to click a button or an icon to denote the selection of a subject in the subject row 505, such as “Science.” Likewise, at the block 410, the teacher user may select one or more grade levels or a range of grade levels as shown in FIG. 5. In this example, the teacher user has chosen “K-2” to denote kindergarten through second grade in the grade level row 510. The activity selection module 210 also enables the teacher user to select a desired template that determines the tasks or objectives of an activity. For instance, in the template row 515, the teacher user selects a “3 Column Chart” that requires a student to choose a particular item from a pool of items and drag the particular item into the appropriate column.

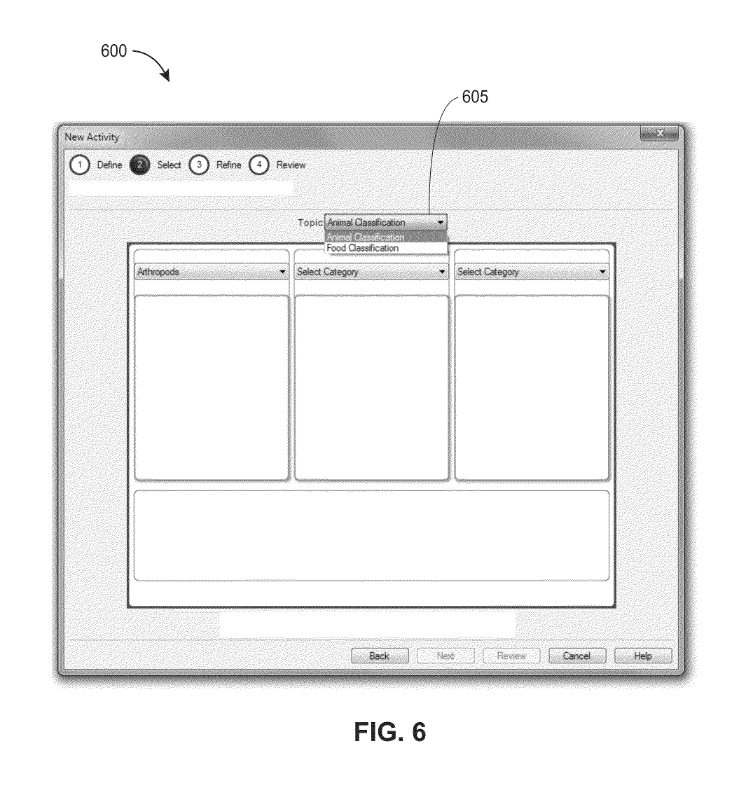

Once the teacher user indicates or otherwise selects one or more subjects, one or more grade levels, and a template type for the activity, a block 415 of FIG. 4 triggers the knowledge database interface module 305 to determine applicable topics associated with the selected one or more subjects and the selected one or more grade levels. The knowledge database interface module 305 queries the knowledge database 105 for any relational data elements that are associated with the selected one or more subjects and the selected one or more grade levels. The knowledge database interface module 305 determines the associated topic with each returned relational data element. The applicable topics may include one or more characteristics such as attributes, attribute values, or attribute value pairs of the returned relational data element. For example, in selecting both the subject of “Science” and the “K-2” grade level, as depicted in FIG. 5, the knowledge database interface module 305 queries the knowledge database 105 for any relational data elements that are associated with both “Science” and “K-2.” In response to the query, the knowledge database interface module 305 receives relational data elements that are associated with the two terms. The knowledge database interface module 305 determines the topic data associated with each returned relational data elements and also determines each unique topic associated with each relational data element. The knowledge database interface module 305 sends the topic data to the activity editor 142 for display. For this example, the topic data associated with the returned relational data elements include “Animal Classification” and “Food Classification” as shown in FIG. 6.

Returning to FIG. 4, at the block 415, the inference engine interface module 205 within activity editor 142 operates to present some or all of the applicable topic data to the teacher user via the user interface 134. Again, the inference engine interface module 205 uses the knowledge database interface module 305 within the inference engine 109 to access the knowledge database 105 within the server 103 to obtain the topic data needed for display. Similar to subject data or grade level data, the topic data may be rendered in text, images, icons, or any other suitable type of data representation. The following chart illustrates an example portion EAV relational data elements for a particular subject (animals) and a particular grade level (K-2):

| ENTITY | ATTRIBUTE | VALUE |
|---|---|---|
| bear | isa | mammal |
| fish | isa | living organism |
| bear | isa | legged animal |
| bear | isa | omnivore |
| forest | isa | habitat |
| lake | isa | habitat |
| river | isa | habitat |
| dolphin | isa | mammal |
| bear | food source | fish |
| fish | habitat | body of water |
| bear | habitat | forest |
| dolphin | habitat | ocean |
| dolphin | locomotion | swim |
| bear | ability | swim |
| dolphin | body part | fins |
| dolphin | body part | tail |
| elephant | habitat | jungle |
| elephant | geographic region | africa |

The returned topics in this example include food sources, habitats, locomotion, abilities, body parts, and geographic regions. The returned topics may also include mammals, living organisms, legged animals, and omnivores from the “isa” attribute (e.g., a bear is a mammal) which represents an inherited property.

As illustrated in FIG. 6, the block 415 may display, in an activity creation window 600 on the user interface 134, the applicable topic data retrieved from the knowledge database 105. In a block 420, the activity selection module 210 in activity editor 142 may enable the teacher user to select a desired topic for the activity. For example, in FIG. 6, the applicable topic data may be selectable via a pull-down menu 605 that denotes each topic in text. Any other means for selection, such as radio buttons, or icons, are suitable as well.

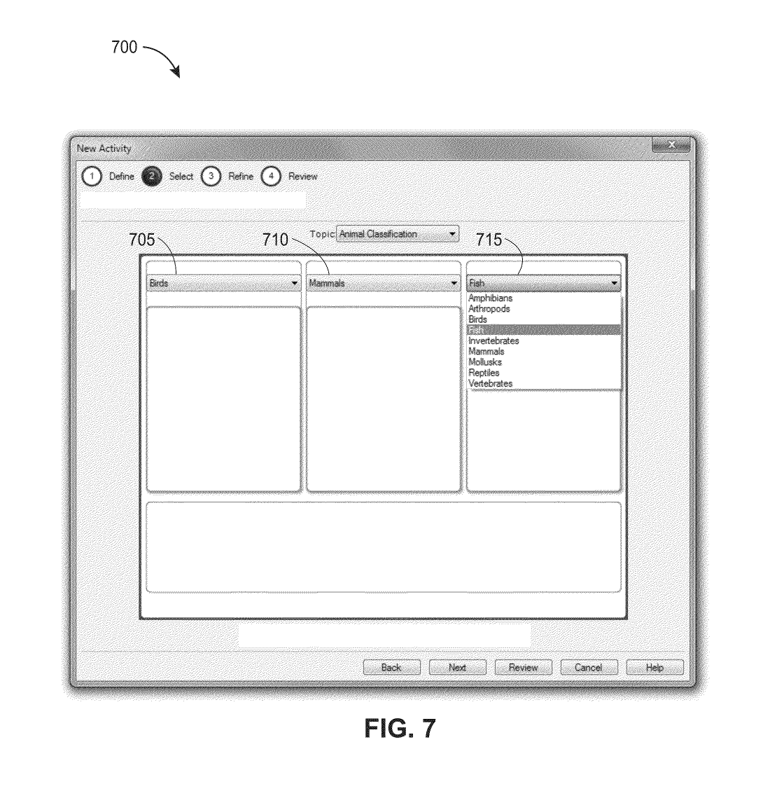

Referring back to FIG. 4, once the teacher user indicates or otherwise selects one or more of the applicable topics to further define the activity, a block 425 implements the knowledge database interface module 305 to determine applicable categories associated with the one or more specified topic. The knowledge database interface module 305 queries the knowledge database 105 to request all the applicable categories associated with the selected one or more topics. The knowledge database 105 returns all relational data elements associated with the specified topic(s), and the knowledge database interface module 305 determines each unique category associated with each relational data element. The applicable categories may include one or more characteristics such as attributes, attribute values, or attribute value pairs of the returned relational data element. For example, as illustrated in FIG. 7, in selecting “Animal Classification” as a topic, the knowledge database interface module 305 queries the knowledge database 105 for all relational elements associated with “Animal Classification.” In response to the query, the knowledge database 105 returns each relational data element to the knowledge database interface module 305 in the inference engine 109 so that each unique category associated each relational data element may be determined. For example, the returned set of relational data elements in response to the “Animal Classification” query is as follows:

| ENTITY | ATTRIBUTE | VALUE |
|---|---|---|
| birds | isa | animal |
| mammals | isa | animal |
| fish | isa | animal |
| vertebrates | isa | animal |
| reptiles | isa | animal |
| amphibians | isa | animal |
| mollusks | isa | animal |
| invertebrates | isa | animal |
| arthropods | isa | animal |

As a result and as illustrated in FIG. 7, the knowledge database interface module 305 within the inference engine 109 determines several example categories that are shown in the right-hand column 715 of the activity creation window 700. For this example, these applicable categories associated with the returned relational data elements include “Amphibians”, “Arthropods”, “Birds”, “Fish”, “Invertebrates”, “Mammals”, “Mollusks”, “Reptiles”, and “Vertebrates.”

Referring back to the FIG. 4, once the teacher user indicates or otherwise selects one or more applicable categories to further define the content of the activity, at a block 435, the asset database interface module 310 queries the asset database 107 to request all the items associated or tagged with one of the selected categories. In response, the asset database 107 returns all or a subset of applicable items that are associated with at least one of the specified categories to the asset database interface module 310 residing in the inference engine 109.

Generally speaking, each test item in the set of returned test items is associated with test item data that includes one or more characteristics. Each returned test item is related to at least one of the other returned test items in the set of test items via test item data (of each respective test item) that share one or more common characteristics. In other words, each returned test item of the plurality of related test items is associated with at least one test item data that includes one or more characteristics, and the relationship between one test item of the plurality of related test items and another test item of the plurality of related test items is determined by one or more common characteristics of at least one test item data of the one test item and of at least one test item data of the other test item. Moreover, these one or more characteristics can be attributes, attribute values, or attribute value pairs. In employing the EAV model specifically, attributes may define topics (e.g., animal classifications), attribute values may define the value of a respective entity or test item data (e.g., animal), and the attribute value pairs may define categories (e.g., mammals). In addition to being directly related via one or more common characteristics, the returned test items may also inherit one or more characteristics from the test item data of other returned test items of the plurality of related test items.

More specifically, the relationship between two test items in the plurality of related test item data may further be defined by one test item (e.g., mammal) that has a test item data (e.g., isa animal) associated with a characteristic (e.g., animal) and another test item (e.g., legged animal) that has a test item data (e.g., isa animal) that shares the same common characteristic (e.g., animal). Moreover, the common characteristic (e.g., animal) may also be an additional test item data of an additional test item, and the additional test item data (e.g., animal) may have one or more additional characteristics (e.g., isa living organism) that may also serve as different test item data of different test items. This structure, some instances, may lead to the original two test items (e.g., mammal and legged animal) inheriting each of the one or more additional characteristics (e.g., isa living organism) as a result of their association with the common and shared characteristic (e.g., animal). Thus, the inference engine 109, in this example, deduces that “a mammal is a living organism” and that “a legged animal is a living organism” from the stored facts that “a mammal is an animal,” “a legged animal is an animal,” and “an animal is a living organism” via the common characteristic of “animal.” This deduction may also be extended to new test items that have test item data (e.g., plant) associated with the common one or more characteristics (e.g., isa living organism) that were inherited by the original two test items (e.g., mammal and animal) so that the new test item (e.g., plant) becomes related to the original two test items (e.g., mammal and animal).

Each characteristic of the one or more characteristics of a test item data of a test item may include at least two types. One type may result in the test item data inheriting additional characteristics associated with one or more characteristics directly associated with the test item data, and a second type may not result in inheritance of additional characteristics associated with one or more characteristics directly associated with the test item data. For example, “a platypus is a mammal” and “a mammal is an animal” leads to the platypus inheriting characteristic of being an animal; however, the additional relational data element, “mammals give live birth” would not, in this instance, lead to the platypus inheriting the characteristic of giving live birth. Additionally, a topic or a category includes either an attribute or an attribute value that is associated with one or more test item data, and upon the selection of the topic or the category, the inference engine 109 returns a plurality of related test items associated with the one or more test item data either directly associated with or inheriting the selected topic, category, or attribute value.

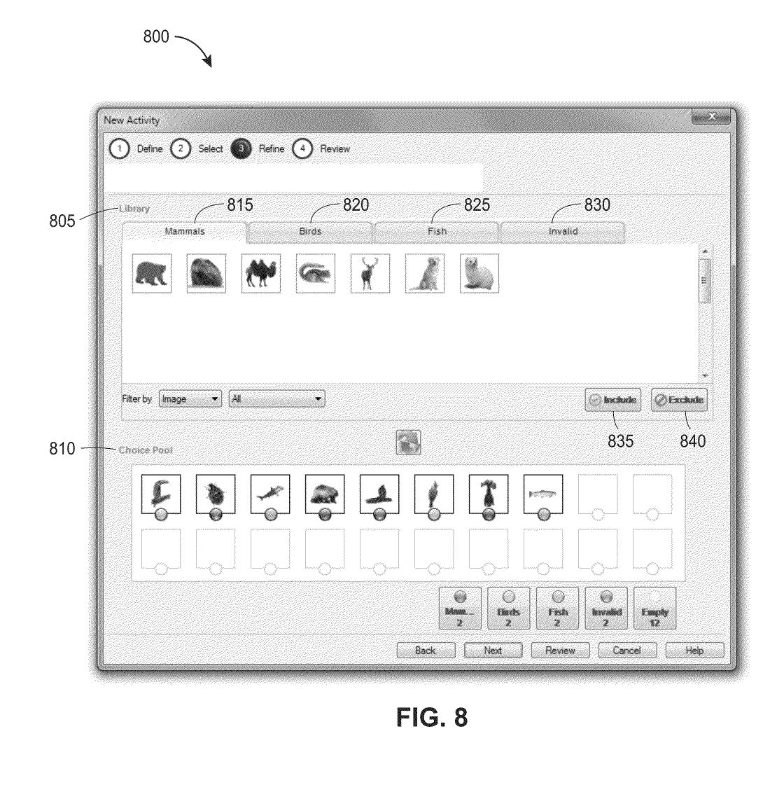

In any event, the returned set of test items may retain their respective tags so that the items may be sorted at a later time. The asset database interface module 310 communicates these returned test items to the activity editor 142 for display. Referring back to FIG. 4, for example, at the block 435, the activity selection module 210 displays in the activity creation window 800, via the user interface 134, a library section 805 and a choice pool area 810. The library section 805 denotes and contains all items associated with a particular category that are available to be tested. The choice pool area 810 denotes items that will appear in the activity after the activity is created. Moreover, in one example embodiment, the asset database interface module 310 randomly populates the choice pool area 810 with a portion of the retrieved items associated with the particular category and a portion of random items that are not associated with the particular category. In one example in FIG. 8, the library section 805 includes four different tabs or groups, in which each group denotes a different selected category (e.g., “Mammals” 815, “Birds” 820, “Fish” 825) except for the last group that represents every category not selected (e.g., “Invalid”). The Invalid group allows for the teacher user to include items that do not belong to any of the selected or tested categories. At the block 435, each group includes the retrieved items from the asset database 107 that are associated with that respective category. As an example, when the teacher user selects the “Mammals” group 815, the library area 805 is populated with items that are associated with mammals. If the teacher user selects a different group, the items associated with that group would appear in the library area 805. Referring to FIG. 8, the choice pool area 810 is a staging area for the teacher user to customize the activity by adding or subtracting particular items to and from the choice pool area 810.

Once the teacher user is satisfied with the items to be tested that are residing in the choice pool area 810, at a block 440, the teacher user may indicate or otherwise select the creation of the activity. At a block 445, the activity creation module 315 creates the activity by associating each item in the choice pool area 810 and the selected template from the block 410 with the activity and stores the activity and associated data in the activity database 111.

Referring back to FIG. 4, at a block 450, the activity execution module 320 detects an authorized student user requesting a stored activity and, at a block 455, retrieves the stored activity associated with the student user from the activity database 111. The activity execution module 320, at a block 460, communicates the activity to a student client 132 of the student user to display via a user interface 150. As example that is illustrated in FIG. 9, the student user performs the activity within an activity window 900 of the user interface 150 that includes a three column format that includes the three categories of “Bird” 905, “Mammal” 910, and “Fish” 915. The student user selects any item in the choice pool area 920 and drags the item to the correct category. For one example task, the item that depicts a bear 925 has been placed correctly in the Mammal column 910, as denoted by the checkmark. However, in another example task, the student user has incorrectly placed the cardinal 930 in the Fish column 915, as denoted by the cross marks.

Referring back to FIG. 4, at the block 465, the activity results module 325 receives the inputs of each task of the student user for the activity and, at a block 470, stores the results data in the student performance database 113. When the teacher user wishes to view or obtain a student's or students' results data for a given activity, the activity evaluation retrieval module 215 in the activity editor 142 requests the results from the activity results module 325 within the inference engine 109. In response to the request, the activity results module 325 retrieves the results data for a given student user, for a given group of student users, or for a given activity. and relays the results data to the activity editor 142 to display via the user interface 134.

In FIG. 4, at a decision block 475, the activity execution module 320 receives an indication of whether to create another activity that uses identical inputs (subject, grade level, topic, category, etc.) gathered from the previously created activity. The teacher user may be prompted by the inference engine 109 to enter an indication on whether to create a new activity based on the same inputs as the most recently created activity. The indication may be also be hardcoded to always or never create a new activity based on the same inputs of the prior activity. A third-party application engine 119 may also provide the indication on whether to create another activity based the identical inputs from the previously created activity. If the indication at the decision block 475 reflects the creation of a new activity, the activity creation module 315 triggers the creation of a new activity at the block 445. In using the identical inputs of the previously created activity, the inference engine 109 via the asset interface database module 310 can generate a new activity that includes an entirely different set of randomized items. Advantageously, the inference engine 109 generates this different set of randomized items all of the same subject, grade level, topic, category, etc. Creating a new activity with the same inputs as the last activity is beneficial for a teacher that may teach multiple sections of a course, each section at a different time, and that may worry about cheating between sections.

Referring back to FIG. 4, if the activity execution module 320 receives a negative indication from the decision block 475 (i.e. a new activity is not to be created with the identical inputs of the previous activity), the activity execution module 320 at decision block 480 receives an indication of whether to create another activity based on the past student or students performance on a previously completed activity or group of activities. The teacher user may be prompted by the inference engine 109 to enter an indication as to whether to create a new activity based on past student performance on previously completed activities. The indication may be also be hardcoded to always or never create a new activity based on past student performance. A application engine 119, which may be third-party, may also provide the indication as to whether to create another activity based past student performance. If the indication at the decision block 480 reflects the creation of a new activity, the activity execution module 320 transfers control to the activity results module 325 at a block 485. At the block 485, the activity results module 325 retrieves student performance results data from the student performance database 113. The inference engine 109 via the activity creation module 315 uses the retrieved student performance results data to determine inputs into creating a new activity (at the block 445) that is specifically tailored to the student or students. For example, if a particular student is struggling with a specific topic or concept, his or her past performance results on previously completed activities will reflect this lack of grasping the topic or concept. In this case, the student will need more practice for the specific topic or concept and more testing of the same or similar test material. Thus, the inference engine 109, at a block 480, may use retrieved student performance results data (stored in the student performance database 113) that is associated with a particular student or students to create a personalized or tailored activity that incorporates past performance results data in determining appropriate inputs for the activity. Advantageously, in using retrieved student performance results data, the inference engine 109 at the blocks 480 and 485 may tailor each subsequent activity for a student or students based on the results of the most recently completed activity. The system behaves in a recursive or feedback manner so that the system can adaptively learn from the results of the students via the results residing in the student performance database 113, or from a change in school-wide or state-wide curriculum changes via an third-party application engine 119. The results may be inputted back into the system on a task-by-task (i.e. question-by-question) basis so that each task is dynamically determined via the inference engine 109 or on an activity-by-activity (i.e. test-by-test) basis so that each activity is dynamically determined. In this manner, the inference engine 109 can automatically adjust the difficulty level when generating subsequent activities based on student performance on prior activities. However, the inference engine 109 need not adjust the difficulty level at all and may maintain the initial teacher-specified values for the subject, difficulty level, or template. Moreover, this method generates an activity much quicker because the system is not waiting for inputs from a teacher user.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, a school environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Still further, the figures depict preferred embodiments of an inference engine system for purposes of illustration only. One skilled in the art will readily recognize from the foregoing discussion that alternative embodiments of the structures and methods illustrated herein may be employed without departing from the principles described herein. Thus, upon reading this disclosure, those of skill in the art will appreciate still additional alternative structural and functional designs for a system and a process for generating electronic activities through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for generating an electronic activity for educational purposes, the method executed by one or more computer processors programmed to perform the method, the method comprising:
receiving subject data specifying one or more subjects to be tested for the electronic activity;
receiving difficulty level data specifying a level of difficulty for any test item to be tested for the electronic activity;
receiving template data specifying a template type for the electronic activity;
using the subject data and the difficulty level data to generate a filtered set of test items; and
creating the electronic activity based on the filtered set of test items and the template type.

2. The method of claim 1, wherein at least one of the receiving subject data, the receiving difficulty level data, or the receiving template data are received manually from a user.

3. The method of claim 1, wherein at least one of the receiving subject data, the receiving difficulty level data, or the receiving template data are received from predetermined values.

4. The method of claim 1, wherein the method further comprises:
maintaining initial value of the received subject data, the initial value of the received difficulty level data, and initial value of the received template data;
regenerating the filtered set of test items based on at least one of the maintained value of the received subject data and the maintained value of the received difficulty level data; and
recreating the electronic activity using the regenerated filtered set of test items and the maintained value of received template data.

5. The method of claim 4, wherein the filtered set of test items is randomly or pseudo-randomly generated from a set of test items limited based on at least one of the maintained value of the received subject data or the maintained value of the received difficulty level data.

6. The method of claim 1, wherein at least one of the receiving subject data, the receiving difficulty level data, or the receiving template data are automatically determined from past performance results data.

7. The method of claim 1, wherein template data includes at least one of a table, an at least two column chart, an at least two row matching table, a Venn diagram, a labeling exercise, a sequencing exercise, a timeline exercise, a life cycle exercise, a cause and effect exercise, a mathematical equation exercise, a scientific formula exercise, a text annotation exercise, or a correction of inaccurate statement exercise.

8. A method for generating an electronic activity for educational purposes, the method executed by one or more computer processors programmed to perform the method, the method comprising:
receiving subject data specifying one or more subjects to be tested for the electronic activity;
receiving difficulty level data specifying a level of difficulty for any topic, any category, or any test item to be tested for the electronic activity;
receiving template data specifying a template type for the electronic activity;
using the subject data and the difficulty level data to determine at least one of a filtered set of topics or categories and displaying at least one of the filtered set of topics or categories to a user;
receiving at least one of topic data or category data specifying one or more topics or categories from the filtered set of topics or categories to be tested for the electronic activity;
using at least one of the topic data or category data to determine a filtered set of test items and sending the filtered set of test items for display to the user;
receiving test item data specifying a set of test items for including in the electronic activity;
creating the electronic activity based on the received set of test items and specified template type; and
storing the activity in the electronic activity database.

9. The method of claim 8, wherein, using the subject data and the difficulty level data to determine a filtered set of topics, using the subject data and the difficulty level data includes:
comparing an indication of a subject associated each of a plurality of relational data elements with the received subject data;
comparing an indication of a difficulty level associated each of a plurality of relational data elements with the received difficulty level data;
selecting each of the plurality of relational data elements that the indication of a subject matches the received subject data and that indication of a difficulty level matches the received difficulty level data;
determining at least one of a topic or category associated with each of the plurality of selected relational data elements; and
creating a filtered set of at least one of topics or categories that includes unique set of determined topics or categories from the plurality of selected relational data elements.

10. The method of claim 8, wherein topic data is received, and wherein the topic data is used to determine a filtered set of categories by:
comparing an indication of a topic associated each of a plurality of relational data elements with the received topic data;
selecting each of a plurality of relational data elements that the indication of a topic matches the received topic data;
determining a category associated with each of the plurality of selected relational data elements; and
creating a filtered set of categories that includes unique set of all determined categories from the plurality of selected relational data elements.

11. The method of claim 8, wherein category data is received, and wherein using the category data to determine a filtered set of test items includes:
comparing an indication of a category associated each of a plurality of test items with the received category data;
selecting each of a plurality of test items that the indication of a category matches the received category data; and
creating a filtered set of test items.

12. The method of claim 8, wherein the difficulty level relates to at least one of: a grade level, a grade range, an age level, or an age range.

13. A activity system for generating an electronic activity for educational purposes, the system comprising:
an activity generation routine stored on one or more computer memories and that executes on one or more computer processors to receive at least one of: (a) subject data specifying one or more subjects to be tested for an electronic activity, (b) difficulty level data specifying a level of difficulty for any topic, any category, or any test item to be tested for an electronic activity, and (c) template data specifying a template type for an electronic activity;
an inference engine topic routine stored on one or more computer memories and that executes on one or more computer processors (a) to determine a filtered set of topics based at least in part on at least one of the subject data and difficulty level data and (b) to send the filtered set of topics for display to a user;
an inference engine category routine stored on one or more computer memories and that executes on one or more computer processors (a) to receive topic data specifying one or more topics from the filtered set of topics to be tested for an electronic active, (b) to determine a filtered set of categories based at least in part on the topic data and (c) to send the filtered set of category for display to a user; and
an inference engine test item routine stored on one or more computer memories and that executes on one or more computer processors (a) to receive category data specifying one or more category from the filtered set of categories to be tested for an electronic activity, (b) to determine a filtered set of test items based at least in part on the category data, and (c) to send the filtered set of test items for display to the user; and
an activity creation routine stored on one or more computer memories and that executes on one or more computer processors (a) to receive test item selection data specifying a set of test items for including in an electronic activity, (b) to create an electronic activity based at least in part on the received set of test items and, (c) to store the electronic activity in an activity database, the stored electronic activity adapted to be used by the one or more students.

14. The activity system of claim 13, wherein the specified set of test items includes a plurality of related test items.

15. The activity system of claim 14, wherein each test item of the plurality of related test items is associated with at least one test item data, the test item data including one or more characteristics, and wherein the relationship between a first test item of the plurality of related test items and a second test item of the plurality of related test items is determined by one or more common characteristics of at least one test item data of the first test item and of at least one test item data of the second test item.

16. The activity system of claim 15, wherein the one or more characteristics can be an attribute, an attribute value, or an attribute value pair.

17. The activity system of claim 14, wherein each test item of the plurality of related test items is associated with one or more test item data of a plurality of test item data, each test item data including one or more characteristics, and wherein each test item of the plurality of related test items is determined by at least one of:
(a) at least one of the test item data of the plurality of test item data of a first test item and at least one of the test item data of the plurality of test item data of a second test item having one or more common characteristics; or
(b) at least one of the test item data of the plurality of test item data of the first test item inheriting one or more characteristics from at least one of the test item data of the plurality of test item data of the second test item that has one or more common characteristics.

18. The activity system of claim 17, wherein the relationships between two test items of the plurality of test items are defined by:
(a) a first test item having a first test item data associated with a first characteristic, the first characteristic being a second test item data; and
(b) a second test item having a third test item data associated with the first characteristic;
wherein the first test item and the second test item are determined to be related based on the common first characteristic of the first test item data and third test item data.

19. The activity system of claim 18, wherein the relationships between each of the plurality of test item data are further defined by:
(a) the second test item data having one or more additional characteristics associated therewith, each of the one or more additional characteristics being a different test item data;
(b) the first and third test item data inheriting each of the one or more additional characteristics as a result of their association with the first characteristic.

20. The activity system of claim 19, wherein the relationships between each of the plurality of test item data are further defined by:
(a) a fourth test item data having at least one of the one or more additional characteristics associated therewith;
wherein the first, third, and fourth test item data are determined to be related based on the common one or more additional characteristics associated to the fourth test item data and inherited by the first and third test item data.
